(19) United States
(12) Patent Application Publication
(10) Pub. No.: US 2024/0038453 A1
(43) Pub. Date: Feb. 1, 2024

(54) DYE SENSITIZED SOLAR CELL, POLYMERIC SOLID-STATE ELECTROLYTE FILM FOR DYE SENSITIZED SOLAR CELL AND MANUFACTURING METHOD THEREOF

(71) Applicant: NATIONAL CHENG KUNG UNIVERSITY, Tainan (TW)

(72) Inventor: Yuh-lang Lee, Tainan (TW)

(73) Assignee: NATIONAL CHENG KUNG UNIVERSITY, Tainan (TW)

(21) Appl. No.: 17/936,837

(22) Filed: Sep. 29, 2022

(30) Foreign Application Priority Data
Jul. 26, 2022 (TW) 111128041

(51) Int. Cl. H01G 9/20; H01G 13/04

(52) U.S. Cl. CPC H01G 9/2009; H01G 13/04

(57) ABSTRACT

A dye-sensitized solar cell, a polymeric solid-state electrolyte film for dye- sensitized solar cells, and a manufacturing method thereof are provided. The manufacturing method comprises the following steps: providing a liquid electrolyte, wherein the liquid electrolyte includes a solvent and an electrolyte material dissolved in the solvent; adding a polymer material into the liquid electrolyte to form a gel electrolyte; applying the gel electrolyte to a carrier to form a colloidal-state film; and evaporating the solvent contained in the colloidal-state film in a vacuum environment, wherein the pressure in the vacuum environment is controlled at 0.01 to 10 torr, the temperature is controlled at 40 to 70° C., and the treatment time is 2 to 100 hours, to form a polymeric solid-state electrolyte film.

### CROSS REFERENCE TO RELATED APPLICATIONS

This application claims the priority of Taiwan Patent Application No. 111128041, filed on Jul. 26, 2022, titled “DYE SENSITIZED SOLAR CELL, POLYMERIC SOLID-STATE ELECTROLYTE FILM FOR DYE SENSITIZED SOLAR CELL AND MANUFACTURING METHOD THEREOF”, and the disclosure of which is incorporated herein by reference.

### FIELD OF INVENTION

The present disclosure relates to a dye-sensitized solar cell, a polymeric solid-state electrolyte film for a dye-sensitized solar cell, and a manufacturing method thereof, in particular to a solvent-free dye-sensitized solar cell, polymeric solid-state electrolyte film for a dye-sensitized solar cell and manufacturing method thereof.

### BACKGROUND OF INVENTION

Nowadays, the two most major global issues are global warming and energy scarcity. The widespread use of traditional energy sources, among other considerations, contributes to an increase in exhaust gas emissions (typically carbon dioxide). To avoid global warming, real approaches for carbon dioxide reduction should be developed. The motivation of scientists and researchers in the world is inventing and utilizing alternative energy sources to lower the energy consumption level and save the environment. Solar cells are one of several renewable energy sources that are regarded green power energy technologies, which are expected can supply continuously endless energy for mankind, to overcome the energy crisis caused by “unclean” energy sources including nuclear power, coal, natural gas, and crude oil.

Photovoltaic systems of the first generation utilized silicon (monocrystalline and polycrystalline) as the basic component and had a conversion efficiency of roughly 25%. This solar cell type requires a high fabrication temperature and complicated process, which leads to a high cost in production. The second-generation is compound films solar devices, which contain more than one element, such as gallium arsenide (GaA), which has a 28% of efficiency, cadmium telluride (CdTe), and copper indium gallium selenide (CIGS), which both has a nearly 20% of efficiency. Hybrid film is the third-generation of solar cells, with dye-sensitized solar cells (DSSC) reaches over 13% of performance.

Among the varied types of solar cells, third-generation solar cells, particularly DSSC, have sparked broad attention due to its potential for simple fabrication, low-cost production, low hazardous material content, high energy conversion efficiency, and durability (more than ten-year lifetime under normal operational condition). As a consequence, when compared to typical photovoltaic devices, DSSC can be seen as a viable alternative to conventional silicon solar cells. For example, O'Regan and Grätzel reported the first effective photovoltaic system based on a mesoporous, nanocrystalline titania electrode sensitized to visible region by the adsorption of a ruthenium bipyridyl dye and utilizing an iodide/iodine redox electrolyte in 1991. The cell using electrolyte in acetonitrile (ACN) solvent can reach the highest performance of 13%. However, the presence of the volatile solvent used in the liquid electrolyte system created new challenges in the convergence of large area modules, complexity in implementing tandem architectures, photo-desorption and degradation of sensitizer in DSSC, the counter electrode corrosion, and self-degradation of some constituents under light effect.

In recent research, quasi-solid (gel) state electrolytes have been proposed as liquid-state electrolyte substitutions. The gel electrolyte DSSC with polymers as gelators reaches up to 10% of performance in the best condition However, gel electrolytes still have a huge amount of flammable organic solvent inside.

Therefore, it is necessary to provide a dye-sensitized solar cell, a polymeric solid-state electrolyte film, and a manufacturing method thereof. By manufacturing a highly efficient and stable polymeric solid-state electrolyte, the existing problems in conventional technology can be solved.

### SUMMARY OF INVENTION

An object of the present disclosure is to provide a dye-sensitized solar cell, a polymeric solid-state electrolyte film, and a manufacturing method thereof. By providing a solvent-free polymer polymeric solid-state electrolyte film, the polymeric solid-state electrolyte film of the present disclosure could reach not only long-term stability but also give the cell less hazard and solvent-free property. The polymeric solid-state electrolyte film of the present disclosure further could avoid the problem that has a poor efficiency of the dye-sensitized solar cell due to decreased interfacial contacts, reduced conductivity, and lower diffusivity.

Another object of the present disclosure is to provide a polymeric solid-state electrolyte film for dye-sensitized solar cells and a manufacturing method thereof, so as to find suitable gelation materials at operational temperature and optimize the fabrication process, thereby improving the efficiency and stability of the solid electrolyte sensitized solar cells.

In order to achieve the above objects, the disclosure provides a manufacturing method of a polymeric solid-state electrolyte film for a dye-sensitized solar cell, includes steps of: providing a liquid electrolyte, wherein the liquid electrolyte includes a solvent and an electrolyte material dissolved in the solvent; adding a polymer material to the liquid electrolyte to form a gel electrolyte; applying the gel electrolyte to a carrier to form a gel electrolyte film; and evaporating the solvent contained in the gel electrolyte film in a vacuum environment, wherein a pressure in the vacuum environment is controlled at 0.01 to 10 torr, a temperature is between 40 to 70 ° C., and a treatment time is 2 to 100 hours to form a polymeric solid-state electrolyte film, wherein the polymeric solid-state electrolyte film is free of the solvent.

In an embodiment of the present disclosure, wherein the solvent is acetonitrile, and the electrolyte material includes 0.1 to 0.01M lithium iodide, 0.03 to 0.3M iodine, 0.166 to 1.66M 4-tert-butylpyridine, 0.003 to 0.03M guanidine thiocyanate, and 0.2 to 2M 1,2-dimethyl-3-propylimidazolium iodide or 0.2 to 2M 1,3-dimehtyl-imidazolium iodide.

In an embodiment of the present disclosure, wherein the step of adding the polymer material to the liquid electrolyte further includes step of: after adding the polymer material to the liquid electrolyte, stirring at 50 to 70° C. for 1 to 5 hours.

In an embodiment of the present disclosure, a polymer material, wherein the polymer material is poly(ethylene oxide), or a mixture of poly(ethylene oxide) and another polymer material, wherein the another polymer material includes polyethylene glycol, polyvinylidene difluoride, poly(vinylidene fluoride-co-hexafluoropropylene), poly(methyl methacrylate), poly(acrylonitrile-co-vinyl acetate), or poly(acrylonitrile).

In an embodiment of the present disclosure, a representative molecular weight of poly(ethylene oxide) ranges from 200,000 g/mol to 900,000 g/mol.

In an embodiment of the present disclosure, the representative molecular weight of poly(ethylene oxide) is 400,000 g/mol.

In an embodiment of the present disclosure, a representative molecular weight of polyethylene glycol ranges from 200 g/mol to 20,000 g/mol.

In an embodiment of the present disclosure, the representative molecular weight of polyethylene glycol is 400 g/mol.

In an embodiment of the present disclosure, wherein a ratio of the polymer material is in an amount by weight of 5 to 20% over the total weight of the gel electrolyte, and a ratio of poly(ethylene oxide) to the another polymer material ranges from 10:0 to 2:8.

In an embodiment of the present disclosure, the step of adding a polymer material to the liquid electrolyte to form a gel electrolyte further comprises adding titanium dioxide nanofillers into the gel electrolyte, wherein the titanium dioxide nanofillers are in a proportion of 2 wt% to 20 wt% by weight of the total weight of the gel electrolyte.

The present disclosure also provides a polymeric solid-state electrolyte film for a dye-sensitized solar cell, including an electrolyte material, wherein the electrolyte material includes 0.1 to 0.01M lithium iodide (LiI), 0.03 to 0.3M iodine (I₂), 0.166 to 1.66M 4-tert-butylpyridine (tBP), 0.003 to 0.03M guanidine thiocyanate (GuSCN), and 0.2 to 2M 1,2-dimethyl-3-propylimidazolium iodide (DMPII) or 0.2 to 2M 1,3-dimehtyl-imidazolium (DMII) iodide (DMII); and a polymer material, wherein the polymer material is poly(ethylene oxide), or a mixture of poly(ethylene oxide)(PEO) and another polymer material, wherein the another polymer material includes polyethylene glycol (PEG), polyvinylidene difluoride (PVDF), poly(vinylidene fluoride-co-hexafluoropropylene) (PVDF-HFP), poly(methyl methacrylate) (PMMA), poly(acrylonitrile-co-vinyl acetate), or poly(acrylonitrile) (PAN), and wherein the polymeric solid-state electrolyte film is free of solvent.

In an embodiment of the present disclosure, a representative molecular weight of poly(ethylene oxide) ranges from 200,000 g/mol to 900,000 g/mol.

In an embodiment of the present disclosure, the representative molecular weight of poly(ethylene oxide) is 400,000 g/mol.

In an embodiment of the present disclosure, a representative molecular weight of polyethylene glycol ranges from 200 g/mol to 20,000 g/mol.

In an embodiment of the present disclosure, the representative molecular weight of polyethylene glycol is 400 g/mol.

In an embodiment of the present disclosure, the polymeric solid-state electrolyte film is free of acetonitrile.

In an embodiment of the present disclosure, a ratio of the polymer material is in an amount of 5 to 20% by weight over the total weight of the polymeric solid-state electrolyte film, and a ratio of poly(ethylene oxide) to the another polymer material ranges from 10:0 to 2:8.

The disclosure further provides a dye-sensitized solar cell, including: a first substrate and a second substrate, a surface of the first substrate facing toward the second substrate has a first electrode, a surface of the second substrate facing toward the first substrate has a second electrode, a surface of the second electrode coated with a nano-porous film formed of titanium dioxide, and the nano-porous film adsorbed with a photosensitive dye; a polymeric solid-state electrolyte film is provided between the nano-porous film and the first electrode, wherein the polymeric solid-state electrolyte film includes: an electrolyte material including 0.1 to 0.01M lithium iodide, 0.03 to iodine, 0.166 to 1.66M 4-tert-butylpyridine, 0.003 to 0.03M guanidine thiocyanate, and 0.2 to 2M 1,2-dimethyl-3-propylimidazolium iodide or 0.2 to 2M 1,3-dimehtyl-imidazolium iodide; a polymer material, wherein the polymer material is poly(ethylene oxide), or a mixture of poly(ethylene oxide) and another polymer material, wherein the another polymer material includes polyethylene glycol, polyvinylidene difluoride, poly(vinylidene fluoride-co-hexafluoropropylene), poly(methyl methacrylate), poly(acrylonitrile-co-vinyl acetate), or poly(acrylonitrile), and the polymeric solid-state electrolyte film is free of solvent.

In an embodiment of the present disclosure, a representative molecular weight of poly(ethylene oxide) ranges from 200,000 g/mol to 900,000 g/mol.

In an embodiment of the present disclosure, the representative molecular weight of poly(ethylene oxide) is 400,000 g/mol.

In an embodiment of the present disclosure, a representative molecular weight of polyethylene glycol ranges from 200 g/mol to 20,000 g/mol.

In an embodiment of the present disclosure, the representative molecular weight of polyethylene glycol is 400 g/mol.

In an embodiment of the present disclosure, the polymeric solid-state electrolyte film is free of acetonitrile, and a ratio of the polymer material is in an amount by weight of 5 to 20% over the total weight of the gel electrolyte, and a ratio of poly(ethylene oxide) to the another polymer material ranges from 10:0 to 2:8.

### BRIEF DESCRIPTION OF DRAWINGS

In order to more clearly explain the technical solutions according to the embodiments of the present application, the following will briefly introduce the drawings that need to be used in the description of the embodiments. It is apparent that the drawings in the following description are only some embodiments of the present application. For those of skilled in the art can obtain other drawings based on these drawings without any creative work.

FIG. 1 is a schematic flowchart of a manufacturing method of a polymeric solid-state electrolyte film for a dye-sensitized solar cell according to the first embodiment of the present disclosure.

FIG. 2 is ion diffusivities and conductivities of various solid-stated electrolyte materials according to the first embodiment of the present disclosure.

FIG. 3 is a schematic flowchart of a manufacturing method of a polymeric solid-state electrolyte film for a dye-sensitized solar cell according to the second embodiment of the present disclosure.

FIG. 4 is a stability comparison diagram of the dye-sensitized solar cell using the polymeric solid-state electrolyte film according to the present disclosure and the dye-sensitized solar cell using the liquid electrolyte.

FIG. 5 is a schematic structural view of a dye-sensitized solar cell using a polymeric solid-state electrolyte film according to an embodiment of the present disclosure.

### DETAILED DESCRIPTION OF EMBODIMENTS

In order to make the purpose, technical scheme, and advantages of the present application more clear, the present application further describes in detail below accompanying the drawings. Referring to the illustration in the drawings, in which the same component symbols represent the same components. The following description is illustrated based on the specific embodiments of the present application, which should not be considered as limitations for other specific embodiments not detailed herein. The term “embodiment” is used herein to mean serving as an example, instance, or illustration.

In the description of the present application, it should be understood that, the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise”, etc. indicate an orientation or positional relationship based on the orientation or positional relationship shown in the accompanying drawings and are intended only to facilitate and simplify the description of the present application, not to indicate or imply that the device or element referred to must have a particular orientation, be constructed and operate in a particular orientation, and therefore cannot be construed as a limitation of the present application. In addition, the terms “first” and “second” are only used for descriptive purposes and cannot be understood as indicating or implying relative importance or implicitly indicating the number of indicated technical features. Thus, the features defining “first” and “second” may explicitly or implicitly include one or more of the features. In the description of the present application, the term “a plurality of” in the description of the present application refer to two or more than two, unless otherwise expressly and specifically limited.

As used herein, the numerical range of a variable is intended to indicate that the variable is equal to any value within that range. Therefore, for an inherently discontinuous variable, the variable is equal to any integer value within that range of values, including the endpoints of the range. Similarly, for a variable that is continuous in itself, the variable is equal to any real value within the numerical range, including the endpoint of the range. As an example, and not as a limitation, if the variable itself is discontinuous, the variable described as having a value between 0 and 2 takes a value of 0, 1, or 2; if the variable itself is continuous, it takes the value of 0.0, 0.1, 0.01, 0.001 or any other real value >0 and <2.

The electrolyte is the heart component in DSSCs. Based on its characteristics, there are three types of electrolytes: liquid, quasi-solid, and solid-state electrolytes. Because liquid electrolyte has leakage and sealing issues, as well as flammability and electrochemical stability issues, the solid electrolyte is an alternative option in DSSCs. Besides, the presence of solvent created new challenges in the convergence of large area modules, complexity in implementing tandem architectures, photo-desorption and degradation of sensitizer in DSSC, the counter electrode corrosion, and self-degradation of some constituents under light effect, all of which leads to shorter photovoltaic cell lifetimes, lower cell efficiency, and practical use. Ionic conductors and hole-transport materials (HTMs) are two types of solid-state electrolytes. The present disclosure focus on using polymer electrolytes thin films as ionic conductor. Polymeric electrolytes, compared to the traditional liquid ones, have relatively low ionic conductivity and high recombination rate at the semiconductor interface and rigid property, which are foremost limitations. As a result, the DSSC that uses polymer electrolytes has worse efficiency than the one that uses liquid ionic electrolytes.

The present disclosure is to successfully fabricate a high-efficiency and stable polymeric solid-state electrolyte. Several practical ways can be applied to enhance the efficiency and stability of solid-state electrolyte DSSC such as finding suitable gelation materials at operational temperature and optimizing the fabrication process. For the polymer selection, the chosen should have high ionic conductivity and stability at the device's operational temperature. Because poly(ethyleneoxide) (PEO) has the high ability to solvate a variety of inorganic salts, which can help in forming polymer electrolytes with significant values of ionic conductivity. PEO stands for polymers having a molecular weight above 20,000 g/mol (this disclosure uses PEO having a representative molecular weight of MW_{PEO}=200,000 g/mol to 900,000 g/mol, for example, 400,000 g/mol), is suitable for gelation and printing process due to its adequate flexibility and excellent film-forming characteristics. However, because of its high molecular mass, PEO severely reduced its conductivity because of crystallinity. The present disclosure proposes to blend other polymers with PEO to suppress crystallization and improve the amorphous and active area so that the polymeric film conductivity could be enhanced. Polyethylene glycol (PEG), which has the same fundamental and chemical structure as PEO and has a tendency to refer to polymers having a molecular weight below 20,000 g/mol (this disclosure uses PEG having a representative molecular weight Mw_{PEG}=200 g/mol to 20,000 g/mol, for example, 400 g/mol), is nominated as a suitable polymer. PEG with its low molecular weight and higher mobility, is expected that it can increase the ion conductivity and diffusivity of the blended polymer after incorporated with PEO. The components, redox pair concentration, electrolyte viscosity, and distance between photoanode and counter electrode all have a substantial impact on charge transfer in electrolytes, which is governed by diffusion factor. Overall, the main objectives of this study can be listed as below: (1) to study the effect of total polymer amount (PEO), polymer blended ratio (PEO/PEG), and additives (TiO₂ nanofillers) in the electrolyte characteristics; (2) to study different fabrication approaches (in-situ solidification and film electrolyte) to enhance the performances of polymeric solid-state DSSCs; (3) to assess how stable the fabricated polymeric solid-state DSSCs are after testing periods.

An embodiment of the present disclosure provides a manufacturing method of a polymeric solid-state electrolyte film for a dye-sensitized solar cell, including the following steps: providing a liquid electrolyte, wherein the liquid electrolyte includes a solvent and an electrolyte material dissolved in the solvent; adding a polymer material into the liquid electrolyte to form a gel electrolyte; applying the gel electrolyte to a carrier to form a colloidal-state film; and evaporating the solvent contained in the colloidal-state film in a vacuum environment, wherein the pressure in the vacuum environment is controlled at 0.01 to 10 torr, the temperature is controlled at 40 to 70 ° C., and the treatment time is 2 to 100 hours, to form a solid-state polymeric solid-state electrolyte film.

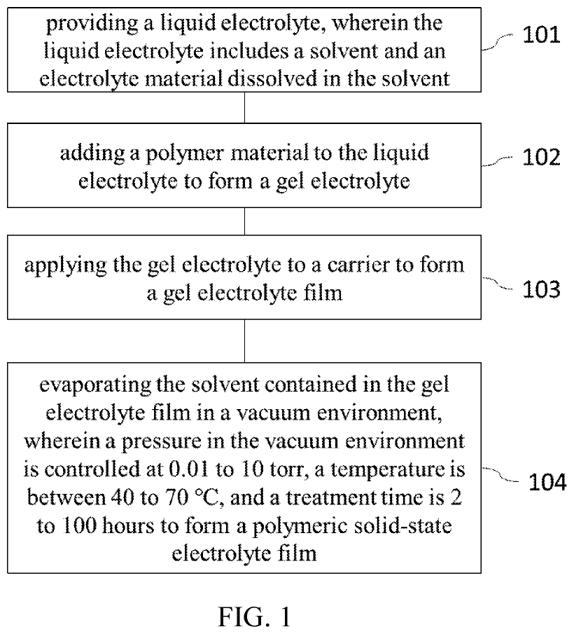

Referring to FIG. 1, which is a schematic flowchart of a manufacturing method of a polymeric solid-state electrolyte film for a dye-sensitized solar cell according to the first embodiment of the present disclosure. First, step 101 is performed to provide a liquid electrolyte, wherein the liquid electrolyte includes a solvent and an electrolyte material dissolved in the solvent. Table 1 shows the physical properties of various solvents used in the electrolyte of dye-sensitized solar cells. Preferably, the solvent is acetonitrile. The use of acetonitrile as a solvent in the electrolyte of the cell can increase its maximum performance. Preferably, the electrolyte material includes 0.1 to 0.01M lithium iodide (LiI), 0.03 to 0.3M iodine (I 2), 0.166 to 1.66M 4-tert-butylpyridine (tBP), 0.003 to 0.03M guanidine thiocyanate (GuSCN), and 0.2 to 2M 1,2-dimethyl-3-propylimidazolium iodide (DMPII) or 0.2 to 2M 1,3 -dimehtyl-imidazolium (DMII) iodide (DMII).

TABLE 1
Physical properties of various solvents used in
the electrolyte of dye-sensitized solar cells

| | | boiling point | viscosity | Dielectric |
|---|---|---|---|---|
| Solvent (abbreviation) | chemical formula | (° C.) | (cp) | constant |
| water | H₂O | 100 | 0.89 | 78 |
| Ethanol (EtOH) | C₂H₅OH | 78 | 1.08 | 25 |
| Acetonitrile (ACN) | CH₃N | 82 | 0.33(30° C.) | 36 |
| 3- | CH₃O(CH₂)₂CN | 164 | 2.5 | 36 |
| Methoxypropionitrile | | | | |
| (MPN) | | | | |
| Valeronitrile (VAN) | CH₃(CH₂)₃CN | 139 | 0.78(19° C.) | 21 |
| Ethylene carbonate | C₅H₁₀OH | 238 | 90 | 90 |
| (EC) | | | | |

According to an embodiment of the present disclosure, 0.1M LiI, 0.03M I₂, 0.6M DMPII, 0.5M tBP, and 0.1 M GuSCN are dissolved in ACN solvent to obtain a liquid electrolyte.

Next, step 102 is performed to add a polymer material to the liquid electrolyte to form a gel electrolyte. Optionally, the polymer material is poly(ethylene oxide) (PEO). PEO is suitable for the production of the polymeric solid-state electrolyte film of the present disclosure because it has the high ability to solvate a variety of inorganic salts and high ability to convert various inorganic salts into solvates, adequate flexibility, and excellent film-forming characteristics. Preferably, the representative molecular weight of PEO of the present disclosure is 400,000 g/mol. In addition, the present disclosure proposes to blend another polymer with PEO to suppress crystallization and improve the amorphous and active area so that the polymeric film conductivity could be enhanced. Optionally, the another polymer material is poly(ethylene oxide), or a mixture of poly(ethylene oxide) and another polymer material, wherein the another polymer material includes polyethylene glycol, polyvinylidene difluoride, poly(vinylidene fluoride-co-hexafluoropropylene), poly(methyl methacrylate), poly(acrylonitrile-co-vinyl acetate), or poly(acrylonitrile). Preferably, the representative molecular weight of PEG is 400 g/mol. PEG (a representative molecular weight of 400 g/mol) is blended with PEO (with a representative molecular weight of 400 000 g/mol) as a co-viscous agent and introduced into the liquid electrolyte as the stiffener to regulate the viscosity of the electrolytes and reduce the self-crystallization of high molecular weight PEO.

Then, step 103 is performed to apply the gel electrolyte to a carrier to form a gel electrolyte film. In an embodiment of the present disclosure, the carrier is a glass. Optionally, the gel electrolyte is formed on the carrier by spin coating, screen printing, or casting. Optionally, the gel electrolyte is applied to a carrier to form a whole piece of colloidal-state film. Alternatively, the carrier has several pre-defined cavities (e.g., the cavities are defined by a Surlyn® film, each cavity has a square deficit with the size of 4.5×4.5 mm), and the gel electrolyte is applied into the cavities.

Thereafter, step 104 is performed to evaporate the solvent contained in the gel electrolyte film in a vacuum environment (e.g., a vacuum oven), wherein the pressure in the vacuum environment is controlled at 0.01 to 10 torr, a temperature is between 40 to 70° C., and a treatment time is 2 to 100 hours to form a polymeric solid-state electrolyte film, wherein the polymeric solid-state electrolyte film is free of the solvent. In particular, the polymeric solid-state electrolyte film may be a whole piece of polymeric solid-state electrolyte film or several separate pieces of polymeric solid-state electrolyte films.

It should be noted that the solvent of the present disclosure does not remain in the polymeric solid-state electrolyte film.

Optionally, the polymeric solid-state electrolyte film is placed on a nano-porous film formed by titanium dioxide on the surface of the photoanode of the dye-sensitized solar cell, and then the opposite electrode is covered on the polymeric solid-state electrolyte film, a clipping force is applied to the photoanode and the opposite electrode, and the polymeric solid-state electrolyte film is heated to melt the polymeric solid-state electrolyte film, thereby helping the electrolyte penetrate into the titanium dioxide film.

Moreover, in an embodiment of the present disclosure, the step of adding the polymer material to the liquid electrolyte further includes step of: after adding the polymer material to the liquid electrolyte, stirring at 50 to 70° C. for 1 to 5 hours.

According to the test results of the present disclosure, if it configures a ratio of the polymer material in an amount by weight of 5 to 20% over the total weight of the gel electrolyte, a ratio of poly(ethylene oxide) to the another polymer material ranges from 10:0 to 2:8, and the electrolyte material is 0.1 to 0.01M lithium iodide (LiI), 0.03 to 0.3M iodine (I₂), 0.166 to 1.66M 4-tert-butylpyridine (tBP), 0.003 to 0.03M guanidine thiocyanate (GuSCN), and 0.2 to 2M 1,2-dimethyl-3-propylimidazolium iodide (DMPII) or 0.2 to 2M 1,3-dimehtyl-imidazolium (DMII) iodide (DMII), the dye-sensitized solar cells can have better performance.

### Effect of PEO/PEG Ratio in Polymeric Electrolyte

From Table 2, DSSC performances improve as the quantity of PEG in the blended polymer increase, reaching the highest performance of 7.50% at a PEO/PEG ratio of 7:3. All the cells with the presence of PEG have better efficiency than that of the cell that just used PEO, owing to higher J_{SC} and FF. As the PEG concentration increases further (at a 5:5 ratio), there is a slight drop in its efficiency. A difference in cell efficiencies of polymeric solid electrolyte DSSC at PEO/PEG with ratios 7:3 and 5:5 is trivial, which all show significant improvement in J_{SC} and performance compared to the one using only PEO as a viscous agent.

TABLE 2
Photovoltaic parameters of polymeric solid-state DSSCs using various ratios
of PEO/PEG according to the first embodiment of the present disclosure

| | | | | Photoelectric | Charge |
|---|---|---|---|---|---|
| | Short-circuit | Open-circuit | | conversion | transfer |
| | current density J_{SC} | voltage V_{OC} | | efficiency η | resistance R_{PT} |
| PEO_{400,000}/PEG₄₀₀ | (mA/cm²) | (V) | Fill factor (FF) | (%) | (Ω · Cm²) |
| liquid | 16.69 ± 0.20 | 0.761 ± 0.001 | 0.699 ± 0.001 | 8.88 ± 0.13 | 1.28 |
| electrolyte | | | | | |
| (acetonitrile) | | | | | |
| 10:0 | 11.24 ± 0.18 | 0.766 ± 0.006 | 0.610 ± 0.003 | 5.25 ± 0.14 | 0.43 |
| 9:1 | 12.56 ± 0.12 | 0.765 ± 0.005 | 0.671 ± 0.002 | 6.45 ± 0.12 | 0.47 |
| 7:3 | 13.89 ± 0.10 | 0.769 ± 0.008 | 0.702 ± 0.001 | 7.50 ± 0.01 | 0.24 |
| 5:5 | 13.88 ± 0.21 | 0.746 ± 0.010 | 0.720 ± 0.002 | 7.45 ± 0.12 | 0.56 |

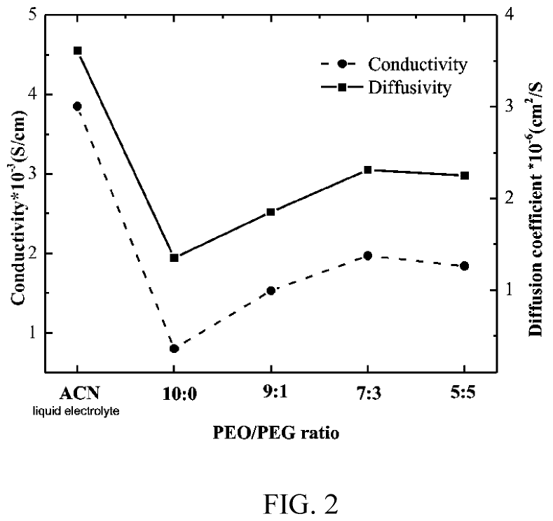

FIG. 2 shows ion diffusivities and conductivities of various solid-state electrolyte materials according to the first embodiment of the present disclosure. Given data in FIG. 2 shows that the conductivity rises significantly (from 0.80 to 1.77 mS/cm) owing to the optimum addition of PEG. Moreover, adding PEG into the electrolyte can improve the diffusivity (from 1.25 to 2.31×10−6 cm²/S) since PEG exists in a shorter polymer chain, which can have higher mobility than PEO. The results show that the inclusion of PEG boosted the solid-state DSSC energy conversion efficiency. The liquid cell using the injection method has an R_{Pt} value of 1.28 Ω.cm². The value decreased dramatically to 0.43 Ω.cm² in the presence of 9 wt% of PEO only. There is a relationship between R_{Pt} and PEO/PEG ratios. The R_{Pt} is reduced by a haft to roughly 0.24 Ω.cm² when PEG is blended with PEO at the appropriate ratio (PEO/PEG 7:3 in this disclosure). It is indicated that the R_{Pt} value decreased significantly suggests that the presence of PEG can improve the charge transfer rate at the electrolyte/Pt contact surface.

### Effects of TiO₂ Nanofillers (NFs) in the Solid-State Electrolyte

The addition of TiO₂ nanofillers into DSSC electrolytes increases the overall energy conversion efficiency. Therefore, TiO₂ nanofillers were also utilized here to improve the performance of the solid-state DSSCs. Various concentrations of TiO₂ nanofillers (5-15 wt%) and PEO/PEG (7:3) were added into the ACN-liquid electrolyte to prepare the gel electrolyte.

The related parameters shown in Table 3 reveal that the Jsc increased with increases in the amount of TiO_{2,} which had a significant effect on the efficiency of the DSSCs. The energy conversion efficiency obtained for the polymeric solid-state electrolyte film dye-sensitized solar cell without TiO₂ nanofillers is 7.50%. When the TiO₂ nanofillers were introduced, the efficiency rises with an increase in the amount of TiO₂, and the maximum efficiency (η=8.07%) was obtained at 10 wt% TiO₂ nanofillers. For polymeric solid-state electrolyte film with and without TiO2 nanofillers, the R_{Pt} values determined from the spectra are 0.601 and 0.290 Ω.cm², respectively. This is because the introduction of TiO₂ nanofillers boosts the electroactivity of the Pt counter electrode. The effect of TiO2 fillers on the performance increase of the solid-state DSSC is mostly due to the nanofillers improved effect on charge transfer at the counter electrode, according to these findings. In a prior study, a similar impact was seen with quasi-solid electrolytes. The exact mechanism underlying this action is still unknown, however, it has been linked to the influence of TiO₂ nanofillers adsorbed on the Pt surface. The presence of TiO₂ nanofillers on the counter electrode is thought to be able to take electrons from the Pt surface and transport them to the electrolytes, hence improving charge transfer at the electrolyte/electrode interface. DSSC electrolytes without nanofillers have a conductivity of 1.43 mS cm⁻¹. In the addition of an optimum concentration of TiO₂ nanofillers, it increases to 3.48×10−6 cm²/S. It is worth noting that the presence of TiO₂ gives an enhancement in the porosity degree, a decrease in crystallinity, and self-aggregation degree of the redox polymeric solid-state electrolyte, hence, increasing conductivity. Finally, IPCE measurements were carried out to analyze the details of the enhanced performance of the DSSC in the presence of TiO₂ nanofillers. According to the analysis of the IPCE spectra for the DSSCs using various electrolytes in the 300-800 nm wavelength region, these DSSCs showed the similar absorbance range in the IPCE spectra because the N719 dye was used for these DSSCs. For the solid-state electrolyte film DSSC without any nanofillers, the IPCE value was reduced which was consistent with the lower J_{SC} of the related cell. For the DS SC using 10 wt% nanofillers, the IPCE spectrum was significantly higher. Therefore, it is preferable that the gel electrolyte further includes titanium dioxide nanofillers in a proportion of 2 wt% to 20 wt% by weight of the total weight of the gel electrolyte.

TABLE 3
Effects of various concentrations of TiO₂ nanofillers on the performance
of DSSCs using the polymeric solid-state electrolyte film

| wt % of TiO₂ | | | | Photoelectric |
|---|---|---|---|---|
| nanofillers with 9 | Short-circuit | Open-circuit | | conversion |
| wt % of PEO/PEG | current density J_{SC} | voltage V_{OC} | | efficiency η |
| 7:3 | (mA/cm²) | (V) | Fill factor (FF) | (%) |
| liquid electrolyte | 16.97 ± 0.10 | 0.748 ± 0.003 | 0.700 ± 0.004 | 8.90 ± 0.04 |
| (acetonitrile) | | | | |
| 0 wt % | 13.56 ± 0.11 | 0.754 ± 0.001 | 0.734 ± 0.002 | 7.50 ± 0.13 |
| 5 wt % | 14.59 ± 0.05 | 0.751 ± 0.005 | 0.723 ± 0.012 | 7.92 ± 0.09 |
| 10 wt % | 15.14 ± 0.09 | 0.749 ± 0.009 | 0.712 ± 0.05 | 8.07 ± 0.10 |
| 15 wt % | 14.26 ± 0.03 | 0.742 ± 0.016 | 0.726 ± 0.03 | 7.69 ± 0.12 |

### Effect of Re-Melting Step in the Polymeric Solid-State electrolyte film Method

The re-melting process is carried out after the polymeric solid-state electrolyte film is put between the photoanode and counter electrode. After polymeric solid-state electrolyte film and electrodes are fixed together by a pair of clips, the cell will be heated at a wide range of temperatures over periods. The main purpose of this process is to re-melt the polymeric solid-state electrolyte film, and make it softer, more flexible, and feasible for the penetration process as PEO is a thermoplastic polymer. The clipping force here helps in pressing the polymeric solid-state electrolyte goes into the TiO₂ nano-porous film. Re-melting at 40° C. to 70° C. (e.g., 50° C.) for 50 to 200 minutes (e.g., 90 minutes) is found to be an optimal condition.

Table 4 provides the electrochemical characteristics of the dummy cell based on electrochemical impedance spectroscopy (EIS) measurement. It can be seen from the data that, heating the film inside electrodes at 50° C. for 90 minutes can enhance diffusivity, and conductivity and decrease the charge transfer resistance at the counter electrode. Those results conclude the positive effect of the polymeric solid-state electrolyte film re-melting in improving electrolyte properties. The efficiency can be enhanced from 1.44% to 6.89%, due to increases in current density, voltage, and fill factor.

TABLE 4
Properties of film electrolyte with and without heat treatment in dummy cells

| | Photoelectric | | | Charge transfer |
|---|---|---|---|---|
| | conversion | | | resistance |
| The polymeric solid- | efficiency η | Diffusivity × | Conductivity × | R_{PT} |
| state electrolyte film | (%) | 10⁻⁶ (cm²/S) | 10⁻³ (S/cm) | (Ω · Cm²) |
| No heat treatment | 1.44 | 1.18 | 0.75 | 0.79 |
| Re-melting at 50° C. for | 6.89 | 1.72 | 1.64 | 0.59 |
| 90 minutes | | | | |

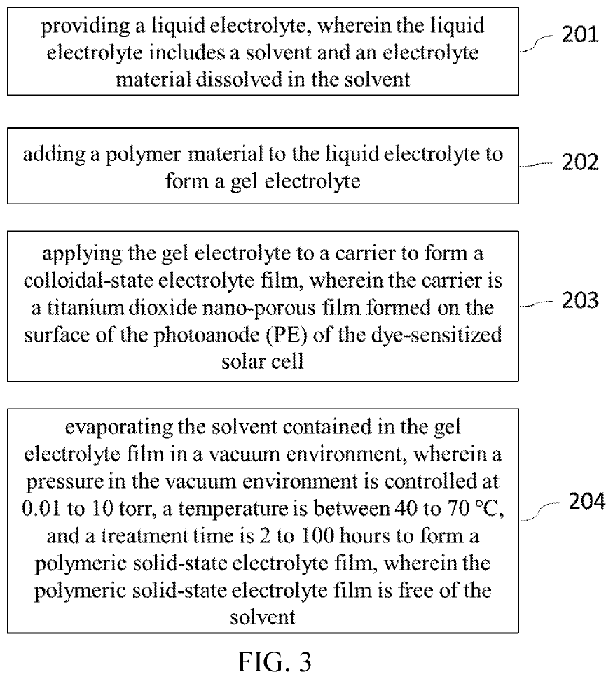

Referring to FIG. 3, which shows a schematic flowchart of a manufacturing method of a polymeric solid-state electrolyte film for dye-sensitized solar cells according to the second embodiment of the present disclosure. The second embodiment of the present disclosure is similar to the first embodiment, with the following differences: after the gel electrolyte is formed, step 203 is performed to apply the gel electrolyte to a carrier to form a colloidal-state electrolyte film, wherein the carrier is a titanium dioxide nano-porous film formed on the surface of the photoanode (PE) of the dye-sensitized solar cell. Optionally, the gel electrolyte is formed on the carrier by spin coating, screen printing, or casting. The carrier has a pre-defined cavity (e.g., the cavity is defined by a Surlyn® film with a square deficit in size of 4.5×4.5 mm), the cavity corresponds to the titanium dioxide nano-porous film, and the gel electrolyte is applied to the cavity to form the colloidal-state electrolyte film. The Surlyn® film can control the amount of gel electrolyte applied. Optionally, after the gel electrolyte is applied to the titanium dioxide nano-porous film on the surface of the photoanode, the opposite electrode is covered on the colloidal-state electrolyte film and a clipping force is applied to the photoanode and the opposite electrode.

Next, similar to step 104, step 204 is performed to evaporate the solvent contained in the gel electrolyte film in a vacuum environment (e.g., a vacuum oven), wherein a pressure in the vacuum environment is controlled at 0.01 to 10 torr, a temperature is between 40 to 70° C., and a treatment time is 2 to 100 hours to form a polymeric solid-state electrolyte film, wherein the polymeric solid-state electrolyte film is free of the solvent.

Table 5 shows that the weight percentage of PEO in the electrolyte in the second embodiment of the present disclosure ranges from 7% to 15% and uses to fabricate the polymeric solid-state electrolyte film. The solidification process is occurred inside the photoanode, at 50° C. under vacuum conditions for haft a day. These cells were then measured under one sun simulator and got the results as illustrated in Table 5. The polymeric solid-state electrolyte film DSSC which used 9 wt% of PEO as a viscous agent can reach the highest efficiency, which is 4.48%, mainly due to an increase in FF (0.630) and simultaneous high value of JSC and VOC (9.49 mA/cm² and 0.749V).

TABLE 5
Photovoltaic data of polymeric state electrolyte using different weight percent of PEO

| | | | | Photoelectric | Charge transfer |
|---|---|---|---|---|---|
| | Short-circuit | Open-circuit | | conversion | resistance |
| | current density J_{SC} | voltage V_{OC} | | efficiency η | R_{PT} |
| PEO (wt %) | (mA/cm²) | (V) | Fill factor (FF) | (%) | (Ω · Cm²) |
| liquid electrolyte | 16.97 ± 0.02 | 0.748 ± 0.001 | 0.700 ± 0.005 | 8.90 ± 0.01 | 1.60 |
| (acetonitrile) | | | | | |
| 7 | 10.04 ± 0.13 | 0.744 ± 0.004 | 0.541 ± 0.005 | 4.04 ± 0.12 | 1.13 |
| 9 | 9.49 ± 0.09 | 0.749 ± 0.003 | 0.630 ± 0.003 | 4.48 ± 0.05 | 0.56 |
| 12 | 9.20 ± 0.14 | 0.752 ± 0.001 | 0.626 ± 0.004 | 4.32 ± 0.16 | 0.73 |
| 15 | 8.11 ± 0.22 | 0.755 ± 0.002 | 0.615 ± 0.002 | 3.77 ± 0.26 | 1.07 |

### Stability of Dye-Sensitized Solar Cells With the Polymeric Solid-State Electrolyte Films

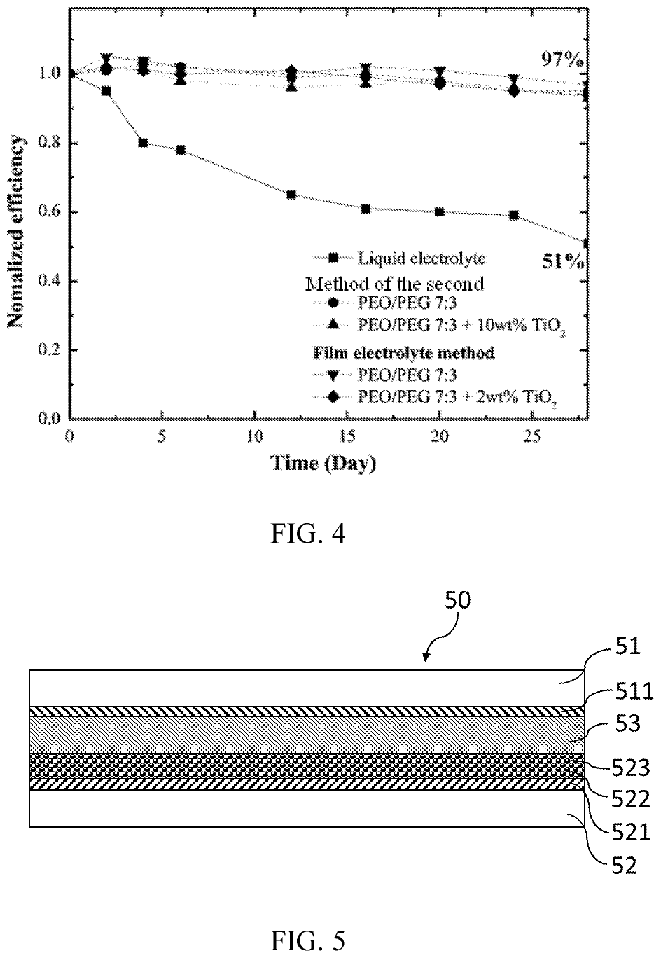

As the energy conversion performance of polymeric solid-state electrolyte film, DSSC is still lower than liquid one, the most important advantage of polymeric solid-state electrolyte film DSSCs is durability. The accelerated aging test is performed at room temperature for a month (around 700 hours) to compare the drop in the efficiencies of DSSC using ACN liquid electrolyte and the polymeric solid-state electrolyte film manufactured by the first and second embodiments of the manufacturing methods of the present disclosure, which is shown in FIG. 4. It is noticeable that polymeric solid-state electrolyte film DSSCs according to the present disclosure witness an increase in their performance during the first 3 days. It is clear that regardless of the polymeric solid-state electrolyte film manufacturing method, DSSC using the polymeric solid-state electrolyte film according to the present disclosure shows long-term stability compared to the liquid one. The polymeric solid-state electrolyte film DSSCs of the first and second embodiments of the present disclosure can maintain up to 97% and 94% of their initial cell performance, respectively. In both methods, the presence of nanofillers decreased the stability of DSSC, mainly because of dye desorption. Meanwhile, ACN liquid electrolyte DSSC can retain just around 51% of its cell performance after one month.

According to the above manufacturing methods, the present disclosure also provides a polymeric solid-state electrolyte film for a dye-sensitized solar cell, including an electrolyte material, wherein the electrolyte material includes 0.1 to 0.01M lithium iodide (LiI), 0.03 to 0.3M iodine (I₂), 0.166 to 1.66M 4-tert-butylpyridine (tBP), to 0.03M guanidine thiocyanate (GuSCN), and 0.2 to 2M 1,2-dimethyl-3-propylimidazolium iodide (DMPII) or 0.2 to 2M 1,3-dimehtyl-imidazolium (DMII) iodide (DMII); and a polymer material, wherein the polymer material is poly(ethylene oxide), or a mixture of poly(ethylene oxide)(PEO) and another polymer material, wherein the another polymer material includes polyethylene glycol (PEG), polyvinylidene difluoride (PVDF), poly(vinylidene fluoride-co-hexafluoropropylene) (PVDF-HFP), poly(methyl methacrylate) (PMMA), poly(acrylonitrile-co-vinyl acetate), or poly(acrylonitrile) (PAN), and wherein the polymeric solid-state electrolyte film is free of solvent.

In an embodiment of the present disclosure, the polymeric solid-state electrolyte film is free of acetonitrile.

In an embodiment of the present disclosure, a ratio of the polymer material is in an amount of 5 to 20% by weight over the total weight of the polymeric solid-state electrolyte film, and a ratio of poly(ethylene oxide) to the another polymer material ranges from 10:0 to 2:8.

Referring to FIG. 5, which show a dye-sensitized solar cell 50 using a polymeric solid-state electrolyte film manufactured by the manufacturing method according to the present disclosure, the dye-sensitized solar cell 50 including a first substrate 51 and a second substrate 52, a surface of the first substrate 51 facing toward the second substrate 52 has a first electrode 511, a surface of the second substrate 52 facing toward the first substrate 51 has a second electrode 521, a surface of the second electrode 521 coated with a nano-porous film 522 formed of titanium dioxide, and the nano-porous film 522 adsorbed with a photosensitive dye 523; a polymeric solid-state electrolyte film 53 is provided between the nano-porous film 522 and the first electrode 511, wherein the polymeric solid-state electrolyte film 53 includes: an electrolyte material, wherein the electrolyte material includes 0.1 to 0.01M lithium iodide (LiI), to 0.3M iodine (I₂), 0.166 to 1.66M 4-tert-butylpyridine (tBP), 0.003 to 0.03M guanidine thiocyanate (GuSCN), and 0.2 to 2M 1,2-dimethyl-3-propylimidazolium iodide (DMPII) or 0.2 to 2M 1,3-dimehtyl-imidazolium (DMII) iodide (DMII); and a polymer material, wherein the polymer material is poly(ethylene oxide), or a mixture of poly(ethylene oxide)(PEO) and another polymer material, wherein the another polymer material includes polyethylene glycol (PEG), polyvinylidene difluoride (PVDF), poly(vinylidene fluoride-co-hexafluoropropylene) (PVDF-HFP), poly(methyl methacrylate) (PMMA), poly(acrylonitrile-co-vinyl acetate), or poly(acrylonitrile) (PAN), and wherein the polymeric solid-state electrolyte film 53 is free of solvent.

In an embodiment of the present disclosure, the polymeric solid-state electrolyte film is free of acetonitrile, and a ratio of the polymer material is in an amount by weight of 5 to 20% over the total weight of the gel electrolyte, and a ratio of poly(ethylene oxide) to the another polymer material ranges from 10:0 to 2:8.

Although the present disclosure has been disclosed in preferred embodiments, it is not intended to limit the scope of the present disclosure. Those skilled in the art can make various changes and modifications without departing from the spirit and scope of the present disclosure. The protection scope of the present disclosure shall be subject to the scope of claims of the patent disclosure.

1. A manufacturing method of a polymeric solid-state electrolyte film for a dye-sensitized solar cell, comprises steps of:
providing a liquid electrolyte, wherein the liquid electrolyte comprises a solvent and an electrolyte material dissolved in the solvent, wherein the solvent is acetonitrile, and the electrolyte material comprises 0.1 to 0.01M lithium iodide, 0.03 to 0.3M iodine, 0.166 to 1.66M 4-tert-butylpyridine, 0.003 to 0.03M guanidine thiocyanate, and 0.2 to 2M 1,2-dimethyl-3-propylimidazolium iodide or 0.2 to 2M 1,3-dimehtyl-imidazolium iodide;
adding a polymer material to the liquid electrolyte to form a gel electrolyte, wherein the polymer material is a mixture of poly(ethylene oxide) and polyethylene glycol, and a ratio of the polymer material is in an amount by weight of 5 to 20% over the total weight of the gel electrolyte, and a ratio of poly(ethylene oxide) to polyethylene glycol ranges from 9:1 to 7:3;
applying the gel electrolyte to a carrier to form a gel electrolyte film; and
evaporating the solvent contained in the gel electrolyte film in a vacuum environment, wherein a pressure in the vacuum environment is controlled at 0.01 to 10 torr, a temperature is between 40 to 70° C., and a treatment time is 2 to 100 hours to form a polymeric solid-state electrolyte film.

2. The manufacturing method according to claim 1, wherein the polymeric solid-state electrolyte film is free of the solvent.

3. (canceled)

4. The manufacturing method according to claim 1, wherein the step of adding the polymer material to the liquid electrolyte further comprises step of: after adding the polymer material to the liquid electrolyte, stirring at 50 to 70° C. for 1 to 5 hours.

5. (canceled)

6. The manufacturing method according to claim 1, wherein a representative molecular weight of poly(ethylene oxide) ranges from 200,000 g/mol to 900,000 g/mol.

7. The manufacturing method according to claim 6, wherein the representative molecular weight of poly(ethylene oxide) is 400,000 g/mol.

8. The manufacturing method according to claim 1, wherein a representative molecular weight of polyethylene glycol ranges from 200 g/mol to 20,000 g/mol.

9. The manufacturing method according to claim 8, wherein the representative molecular weight of polyethylene glycol is 400 g/mol.

10. (Canceled)

11. (Canceled)

12. (Canceled)

13. (Canceled)

14. (Canceled)

15. (Canceled)

16. (Canceled)

17. (Canceled)

18. (Canceled)

19. (Canceled)

20. (Canceled)
